(19) United States
(12) Patent Application Publication
(10) Pub. No.: US 2018/0349095 A1
(43) Pub. Date: Dec. 6, 2018

(54) LOG-STRUCTURED MERGE TREE BASED DATA STORAGE ARCHITECTURE

(71) Applicant: ScaleFlux, Inc., San Jose, CA (US)

(72) Inventors: Qi Wu, San Jose, CA (US); Ning Zheng, San Jose, CA (US); Yong Peng, Milpitas, CA (US); Tong Zhang, Albany, NY (US)

(21) Appl. No.: 15/968,828

(22) Filed: May 2, 2018

Related U.S. Application Data
(60) Provisional application No. 62/515,681, filed on Jun. 6, 2017.

(51) Int. Cl. G06F 7/14; G06F 17/30; G06F 3/06

(52) U.S. Cl. CPC G06F 7/14; G06F 17/30327; G06F 3/0604; G06F 3/067; G06F 3/0644; G06F 3/0659; G06F 3/0643

(57) ABSTRACT

A system, method and program product for implementing an LSM tree data store in a storage infrastructure. A system is disclosed having: a system for handling read requests and write requests using a key-value pair index to store and retrieve data in an LSM data store; and a compaction manager that reorganizes data in the LSM data store using: a partition system that (a) partitions a first level file into a set of subfiles when a partition threshold is exceeded, and (b) stores the subfiles from the first level file in an intermediate level between the first level and a second level, wherein the subfiles are partitioned by range to correspond with files in the second level; and a merge system that merges a group of files comprising a second level file with one or more corresponding subfiles when a merge threshold is exceeded.

### PRIORITY CLAIM

This application claims priority to co-pending provisional application Ser. No. 62/515,681 filed on Jun. 6, 2017 entitled “Reducing write amplification in log-structured merge tree based data stores,” the contents of which is hereby incorporated by reference.

### TECHNICAL FIELD

The present invention relates to the field of storage architectures, and particularly to a storage architecture for reducing the write amplification factors in data stores using log-structured merge tree data structures.

### BACKGROUND

Log-structured merge (LSM) tree data structures have been used in many high-performance data stores, such as BigTable, HBase, RocksDB, and Apache Cassandra. LSM trees maintain key-value pairs, and typically organize key-value pair data in multiple levels, denoted as level-0, level-1, and so on. Each level contains a collection of immutable files, and each immutable file contains a number of key-value pairs that are typically sorted based on their keys. Except level-0, the key ranges of all the files on each level do not overlap with each other. Any changes to the data store (e.g., adding new data, overriding or deleting old data) are inserted into a level-0 file and then migrated to level-1. In order to ensure that all the level-1 files do not have overlapping key ranges, a process called compaction must be invoked when the data store migrates data from one level to the next level. The compaction process merges the data from level-0 with several existing level-1 files, generates several new level-1 files, and deletes the old files. Once level-1 has too many files, the data store will migrate one level-1 file to level-2 by invoking the compaction process. The same process will repeat as more data are inserted into the data store.

Over the periodic compaction processes, the same key-value pair is moved from one file to another file on the same level multiple times, before it is moved to a file on the next level. This however leads to the write amplification issue of LSM trees, i.e., for each key-value pair which is inserted into the LSM tree data store, the data store internally writes this key-value pair multiple times to the storage device. It is highly desirable to minimize the write amplification factor in LSM tree data stores, which will directly improve the overall system performance and reduce the stress on the underlying storage devices. This invention aims to reduce the write amplification factor in LSM tree data stores.

### SUMMARY

The present invention improves computing operations, and in particular improves large scale data store operations that utilize LSM trees. In particular, the present approach reduces computational overhead and the write amplification factor associated with LSM tree data stores.

A first aspect provides a storage infrastructure that implements an LSM tree data store, comprising: a system for handling read requests and write requests using a key-value pair index to store and retrieve data in an LSM data store; and a compaction manager that reorganizes data in the LSM data store using: a partition system that (a) partitions a first level file into a set of subfiles when a partition threshold is exceeded, and (b) stores the subfiles from the first level file in an intermediate level between the first level and a second level, wherein the subfiles are partitioned by range to correspond with files in the second level; and a merge system that merges a group of files comprising a second level file with one or more corresponding subfiles when a merge threshold is exceeded.

A second aspect provides a computer program product stored on a computer readable storage medium, which when executed by a computing system implements an LSM tree data store architecture, comprising: program code for handling read requests and write requests using a key-value pair index to store and retrieve data in an LSM data store; and program code that reorganizes data in the LSM data store using: program code that (a) partitions a first level file into a set of subfiles when a partition threshold is exceeded, and (b) stores the subfiles from the first level file in an intermediate level between the first level and a second level, wherein the subfiles are partitioned by range to correspond with files in the second level; and program code that merges a group of files comprising a second level file with one or more corresponding subfiles when a merge threshold is exceeded.

A third aspect provides a method for implementing an LSM tree data store architecture within a storage infrastructure, comprising: partitioning a first level file into a set of subfiles when a partition threshold is exceeded; storing the subfiles from the first level file in an intermediate level between the first level and a second level, wherein the subfiles are partitioned by range to correspond with files in the second level; and merging a group of files comprising a second level file with one or more corresponding subfiles when a merge threshold is exceeded.

### BRIEF DESCRIPTION OF THE DRAWINGS

The numerous advantages of the present invention may be better understood by those skilled in the art by reference to the accompanying figures in which:

FIG. 1 depicts a computing system having an LSM tree data storage architecture.

FIG. 2 illustrates the leveled structure in an LSM tree data store.

FIG. 3 illustrates write amplification induced by the compaction process.

FIG. 4 illustrates a two-stage compaction process in accordance with an embodiment of the invention.

FIG. 5 illustrates an operational flow diagram of implementing two-stage compaction in accordance with an embodiment of the invention.

FIG. 6 illustrates a combined compaction process in accordance with an embodiment of the invention.

### DETAILED DESCRIPTION

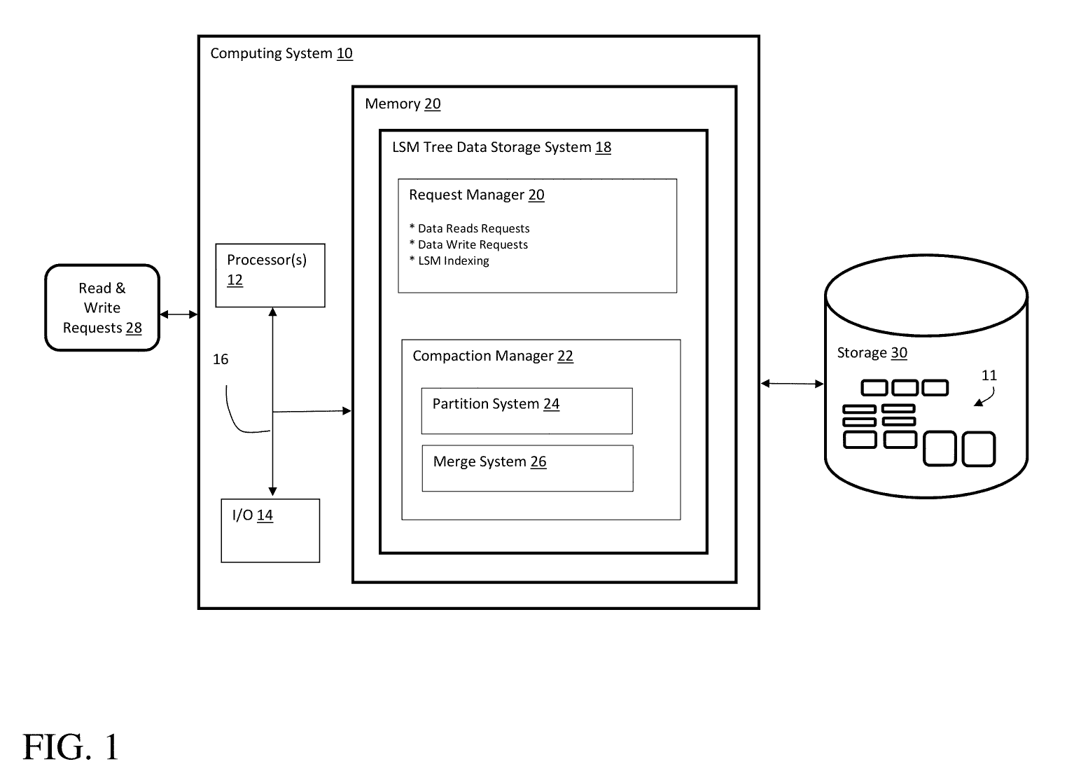

Reference will now be made in detail to the presently preferred embodiments of the invention, examples of which are illustrated in the accompanying drawings. FIG. 1 depicts a storage infrastructure with a computing system 10 having an LSM tree data storage system 18 that implements an LSM tree storage architecture. LSM tree data storage system 18 generally includes: a request manager 20 that handles data read and write requests 28 for accessing and storing data in storage 30 using an LSM pair-value indexing system; and a compaction manager 22 that separately processes data within an LSM tree data store 11 in storage 30. Request manager 20 utilizes, e.g., key-value pairs to store and access data from the enhanced LSM tree data store 11 in storage 30 using, e.g., known techniques. Compaction manager 22 reorganizes data in the LSM tree data store 11 as a background operation using an enhanced compaction process. In particular, data reorganization is implemented using a compaction scheme implemented with a partition system 24 and a merge system 26 that avoid much of the computational overhead and write amplification issues that occur in traditional approaches.

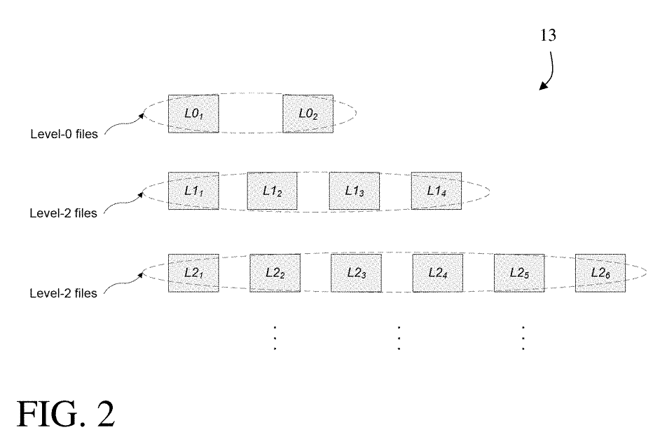

In a traditional LSM tree data store 13, such as that shown in FIG. 2, key-value pairs are organize in a leveled structure. Each level contains a number of immutable files, and each file contains a number of key-value pairs. Except for the files on level-0, the key ranges of all the files on the same level do not overlap with each other. Any changes to the data store 13 (e.g., adding new data, overriding or deleting old data) are inserted into a level-0 file and then migrated to level-1. In order to ensure that all the level-1 files do not have overlapping key ranges, a process called compaction must be invoked when the data store migrates data from level-0 to level-1. The compaction process merges the data from level-0 with several existing level-1 files, generates several new level-1 files, and deletes the old files. Once level-1 has too many files, the data store 13 will migrate one level-1 file to level-2 by invoking the compaction process. The same process will repeat as more data are written into the data store 13.

Over the episodic compaction processes, the same key-value pair is moved from one old file to another new file on the same level multiple times, before it is moved to a file on the next level. This leads to significant computational overhead and write amplification when utilizing a traditional LSM tree, i.e., for each key-value pair which is inserted into the LSM tree data store, the data store 13 internally writes this key-value pair multiple times to the storage device.

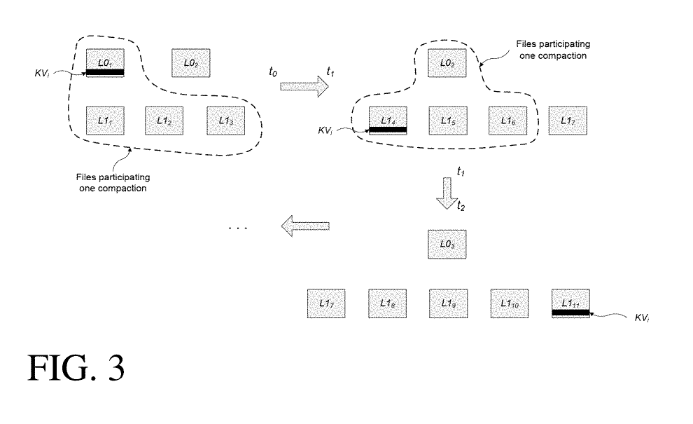

FIG. 3 further illustrates how write amplification occurs. Assume the key-value pair KVᵢ is being held by the level-0 file L0₁ at the time t₀. A first compaction process merges the level-0 file L0₁ with several level-1 files, and generates several new level-1 files. As a result, at t₁, the key-value pair KVᵢ is now in the level-1 file L1₄. Later on, at t₂, a second compaction process merges another level-0 file L0₂ with several level-1 files including L1₄. As a result, the key-value pair KVᵢ is now in the level-1 file L1₁₁. Hence, while staying on the same level-1, the key-value pair KVᵢ has been written to the storage devices twice. As more data are inserted into the data store, the key-value pair KVᵢ will be written again at the level-1, and eventually migrates to level-2. From this example, one can see that the periodic compaction process tends to write the same data content multiple times (in different files) at each level, leading to write amplifications.

In the traditional approach, each compaction process thus carries out the following operations: (1) read the level-j file which has been chosen to be migrated to level-(j+1), (2) read all the level-(j+1) files whose key ranges overlap with that of the chosen level-j file, (3) merge the key-value pairs in all the files and partition the merged key-value pairs into several new files, and write the new files to level-(j+1).

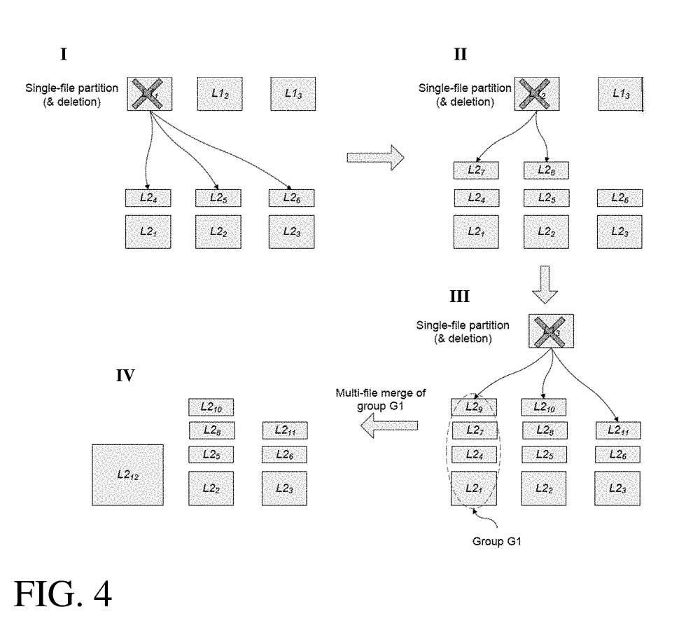

FIG. 4 depicts an example of an enhanced compaction method that reduces write amplification and computational overhead, thus improving the operation of the storage infrastructure. Compaction manager 22 (FIG. 1) carries out compaction using an enhanced process consisting of two separate stages: (1) single-file partition implemented with partition system 24, and (2) multi-file merge implemented with merge system 26, which can operate and be triggered independently of each other. In the example shown, there are several partitioning operations (I-II, II-III) and one merge operation (III-IV).

Partitioning is triggered when the first level files exceed a partition threshold (i.e., size of the entire file set, size of a subset of files, etc.). Thus for example, when the size of all level-1 files, e.g., L1₁₋₃, exceeds a threshold size, partition system 24 partitions a selected file, e.g., L1₁, into three subfiles L2₄, L2₅, and L2₆, which are written to an intermediate level between level-1 and level-2. The key range of each subfile are partitioned by range to correspond with files in the second level. For example, if the ranges of the three files in the second level were:

| File | Key Range |
|---|---|
| L2₁ | 1-1000 |
| L2₂ | 1001-2000 |
| L2₃ | 2001-3000 |

The first subfile L2₄ would contain key values between 1-1000, the second subfile L2₅ would contain key values between 1001-2000, and the third subfile L26 would contain key values between 2001-3000.

The key range of each newly partitioned subfile from a first level file thus corresponds with an existing second level file, i.e., the key range of the new file L24 corresponds with the key range of the existing level-2 file L21; the key range of the new file L2₅ corresponds with that of the existing level-2 file L22; and the key range of the new file L26 corresponds with that of the existing level-2 file L23. After the partitioning, the old partitioned file L1₁ is deleted.

As shown, a second partitioning operation (II-III) partitions a level-1 file L1₂ into two files L2₇ and L2₈, which are written to another intermediate level between level-1 and level-2. The key range of the new file L2₇ corresponds with the combined key range of L2₄ and L2₁. The key range of the new file L2₈ corresponds with the combined key range of L2₅ and L2₂. (Note that no part of the level-1 file L1₂ corresponds with L2₆ and L2₃.)

The partitioning process of files in level-1 will continue over time and after some period of time, each level-2 file will have several intermediate files as shown in III, e.g., there are three intermediate level files being associated with the level-2 file L2₁, denoted as a file group G₁.

When the size of a file group exceeds a predefined merge threshold, merge system 26 implements a multi-file merge process to merge all the files in the file group. In the example shown, a new level-2 file L2₁₂ is generated from file group G₁, and G₁ is then deleted as shown in V. Similar merge processes would likewise be applied to other file groups when then exceed the threshold. The single file partition and multi-file merge processes may be invoked and performed independently from each other.

Using this two-stage compaction process, each key-value pair is only written to one level once, leading to much less write amplification and computational overhead compared with traditional compaction practice. In particular, multiple files on a given level need not be loaded at the same time into the CPU for processing. Instead, only a single file needs to read into the CPU for partitioning, and only a relatively small file group (who's key value pairs fall into a limited range) need to be processed for merging.

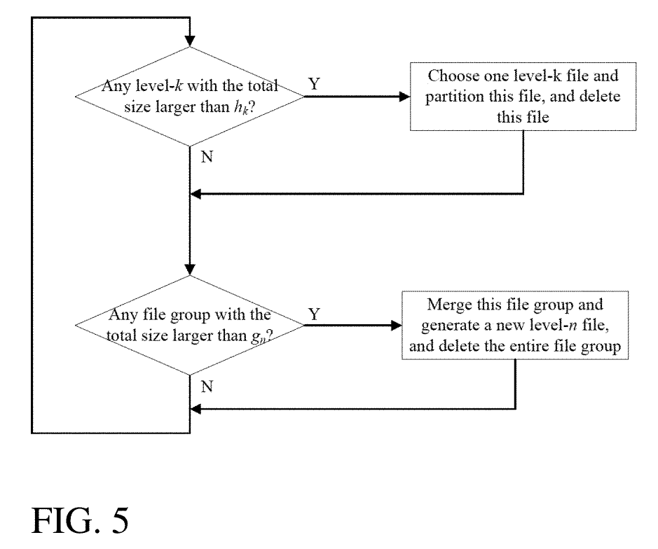

FIG. 5 shows one illustrative embodiment of an operational flow diagram for implementing the two-stage compaction strategy. Initially, the LSM tree data store sets a maximum total size (i.e., threshold) of all the files on each level. Let hᵢ denote the maximum total size of all the files on level-i. Meanwhile, let threshold gᵢ denote the maximum total size of one file group on level i.

As shown in FIG. 5, if the total size of the level-k is larger than hₖ, the single-file partition process is applied to a chosen file (e.g., based on file size, file age, etc.). The process could alternatively process files on level-k if an individual file exceeded a size threshold.

Next, a determination is made whether there is a level-n group that is larger than gₙ (or alternatively, whether a group contains more than a specified number of files, exceeds an age, etc.), then all the files in this group are merged into a single file and this new file is written to level-n. Note that the partition process and merge process can operate independently on different levels, e.g., in which k and n are incremented through all the levels independently of each other. Further, although shown as a single process in FIG. 5, the two processes could operate in two separate computational threads.

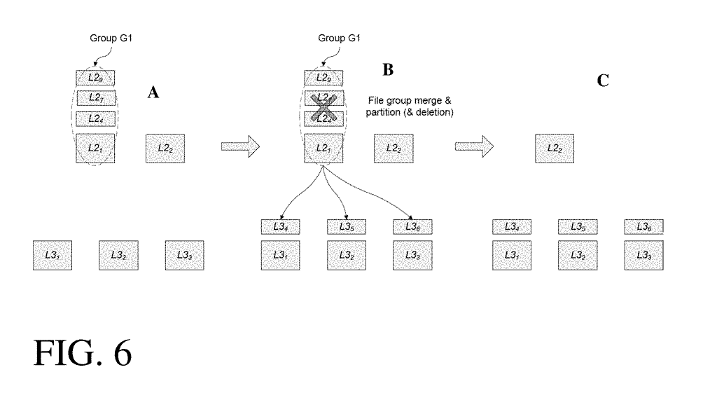

The two processes in the enhanced compaction method, i.e., single-file partition and multi-file merge, could also be integrated as shown in FIG. 6. In particular, once a file group on level-i has been merged, instead of writing the merged data to a single level-i file, the compaction process could immediately partition the merged data into multiple subfiles and write them to a next intermediate levels between level-i and level-(i+1). As shown in A, a file group G1 is identified as being ready to merge. In B, G1 is both merged and partitioned at the same time, resulting in an intermediate level between level-2 and level-3. Once G1 is merged and partitioned, the file group G1 is deleted as shown in C.

It is understood that LSM Tree Data Storage System 18 may be implemented as a computer program product stored on a computer readable storage medium.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computing system 10 that may comprise any type of computing device and for example includes at least one processor 12, memory 20, an input/output (I/O) 14 (e.g., one or more I/O interfaces and/or devices), and a communications pathway 16. In general, processor(s) 12 execute program code which is at least partially fixed in memory 20. While executing program code, processor(s) 12 can process data, which can result in reading and/or writing transformed data from/to memory and/or I/O 14 for further processing. The pathway 16 provides a communications link between each of the components in computing system 10. I/O 14 can comprise one or more human I/O devices, which enable a user to interact with computing system 10. Computing system 10 may also be implemented in a distributed manner such that different components reside in different physical locations.

Furthermore, it is understood that the LSM Tree Data Storage System 18 or relevant components thereof (such as an API component, agents, etc.) may also be automatically or semi-automatically deployed into a computer system by sending the components to a central server or a group of central servers. The components are then downloaded into a target computer that will execute the components. The components are then either detached to a directory or loaded into a directory that executes a program that detaches the components into a directory. Another alternative is to send the components directly to a directory on a client computer hard drive. When there are proxy servers, the process will select the proxy server code, determine on which computers to place the proxy servers' code, transmit the proxy server code, then install the proxy server code on the proxy computer. The components will be transmitted to the proxy server and then it will be stored on the proxy server.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

1. A storage infrastructure that implements an LSM tree data store, comprising:
a system for handling read requests and write requests using a key-value pair index to store and retrieve data in an LSM data store; and
a compaction manager that reorganizes data in the LSM data store using:
a partition system that (a) partitions a first level file into a set of subfiles when a partition threshold is exceeded, and (b) stores the subfiles from the first level file in an intermediate level between the first level and a second level, wherein the subfiles are partitioned by range to correspond with files in the second level; and
a merge system that merges a group of files comprising a second level file with one or more corresponding subfiles when a merge threshold is exceeded.

2. The storage infrastructure of claim 1, wherein the merge system stores a merged group of files in the second level.

3. The storage infrastructure of claim 1, wherein a merged group of files is immediately partitioned and stored in a next intermediate level.

4. The storage infrastructure of claim 1, wherein the partition threshold comprises a total size of all files in a level.

5. The storage infrastructure of claim 4, wherein the first level file is selected based on one of file size and age.

6. The storage infrastructure of claim 1, wherein the merge threshold comprises a predefined total size of all files in a group.

7. The storage infrastructure of claim 1, wherein the merge threshold comprises a predefined number of files in a group.

8. A computer program product stored on a computer readable storage medium, which when executed by a computing system implements an LSM tree data store architecture, comprising:
program code for handling read requests and write requests using a key-value pair index to store and retrieve data in an LSM data store; and
program code that reorganizes data in the LSM data store using:
program code that (a) partitions a first level file into a set of subfiles when a partition threshold is exceeded, and (b) stores the subfiles from the first level file in an intermediate level between the first level and a second level, wherein the subfiles are partitioned by range to correspond with files in the second level; and
program code that merges a group of files comprising a second level file with one or more corresponding subfiles when a merge threshold is exceeded.

9. The program product of claim 8, wherein the program code that merges stores a merged group of files in the second level.

10. The program product of claim 8, wherein a merged group of files is immediately partitioned and stored in a next intermediate level.

11. The program product of claim 8, wherein the partition threshold comprises a total size of all files in a level.

12. The program product of claim 11, wherein the first level file is selected based on one of file size and age.

13. The program product of claim 8, wherein the merge threshold comprises a predefined total size of all files in a group.

14. The program product of claim 8, wherein the merge threshold comprises a predefined number of files in a group.

15. A method for implementing an LSM tree data store architecture within a storage infrastructure, comprising:
partitioning a first level file into a set of subfiles when a partition threshold is exceeded;
storing the subfiles from the first level file in an intermediate level between the first level and a second level, wherein the subfiles are partitioned by range to correspond with files in the second level; and
merging a group of files comprising a second level file with one or more corresponding subfiles when a merge threshold is exceeded.

16. The method of claim 15, wherein merging stores a merged group of files in the second level.

17. The method of claim 15, wherein a merged group of files is immediately partitioned and stored in a next intermediate level.

18. The method of claim 15, wherein the partition threshold comprises a total size of all files in a level.

19. The method of claim 18, wherein the first level file is selected based on one of file size and age.

20. The method of claim 15, wherein the merge threshold comprises one of a predefined total size of all files in a group and a predefined number of files in a group.
